(19) United States
(12) Patent Application Publication
(10) Pub. No.: US 2022/0132749 A1
(43) Pub. Date: May 5, 2022

(54) ABSORBENT ECOLOGICAL FABRIC

(71) Applicant: Wei-Ting Chien, Changhua County (TW)

(72) Inventor: Wei-Ting Chien, Changhua County (TW)

(21) Appl. No.: 17/084,122

(22) Filed: Oct. 29, 2020

(51) Int. Cl. A01G 9/02; D03D 1/00; D03D 3/08; A01G 17/00; A01G 17/06; A01G 24/40

(52) U.S. Cl. CPC A01G 9/025; D03D 1/00; D03D 3/08; D03D 2700/0177; A01G 17/06; A01G 24/40; A01G 17/005

(57) ABSTRACT

An absorbent ecological fabric is provided, including: at least one first fiber element, each of the at least one first fiber element being absorbent and elongate, each of the at least one first fiber element being woven by a plurality of filaments. The absorbent ecological fabric can provide a large region for plants to attach and climb.

### BACKGROUND OF THE INVENTION

### Field of the Invention

The present invention relates to an absorbent ecological fabric.

### Description of the Prior Art

Nowadays, many buildings or equipment are greened with climbing plants. In order to enable plants to grow well, the ecological cloth is used for plant roots to attach and climb. The conventional ecological cloth, such as one disclosed in TWM390654, cannot effectively provide plant water. This type of conventional ecological cloth includes a surface layer, the surface layer includes a plurality of receivers to plant plants, which is complicated and cost a lot.

In order to improve the water retention of the conventional ecological cloth, the conventional ecological cloth is provided with an absorbent cotton layer disposed therewithin. Therefore, plants can only be planted in the receivers, otherwise the plants cannot obtain sufficient amount of water from the absorbent cotton layer. This makes the manufacturing process and cost of the conventional ecological cloth too high, and the planting range is much limited.

The present invention is, therefore, arisen to obviate or at least mitigate the above-mentioned disadvantages.

### SUMMARY OF THE INVENTION

The main object of the present invention is to provide an absorbent ecological fabric which has good water absorption, can provide a large area for plants to attach and climb, and has a simple structure.

To achieve the above and other objects, an absorbent ecological fabric is provided, including: at least one first fiber element, each of the at least one first fiber element being absorbent and elongate, each of the at least one first fiber element being woven by a plurality of filaments.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a drawing showing application according to a preferable embodiment of the present invention;

FIG. 2 is a drawing showing an absorbent ecological fabric of a preferable embodiment of the present invention;

FIG. 3 is a partial enlargement of FIG. 2; and

FIG. 4 is a cross-sectional view, taken along line A-A, of FIG. 3 according to a preferable embodiment of the present invention.

### DETAILED DESCRIPTION OF THE PREFERRED EMBODIMENTS

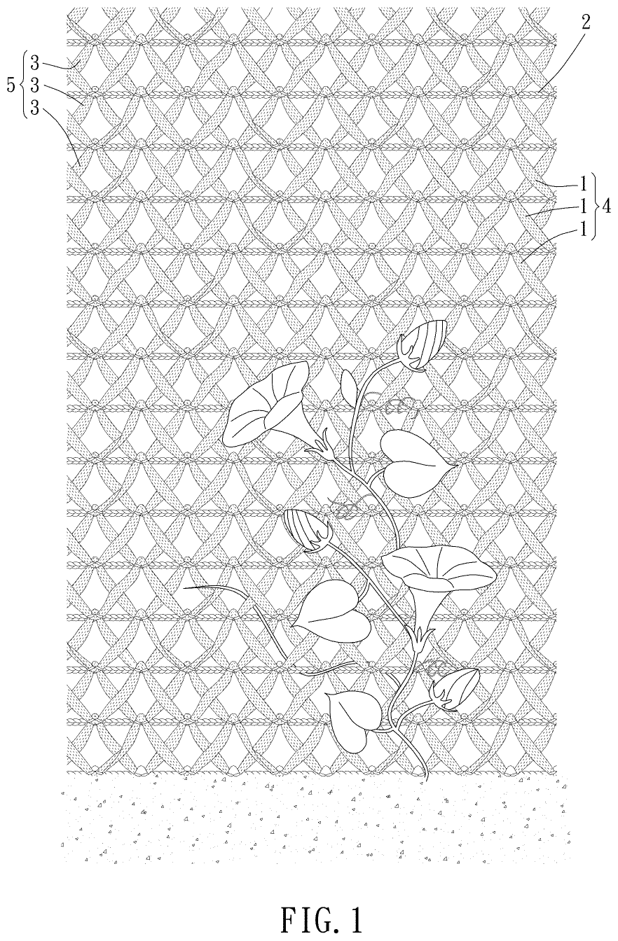

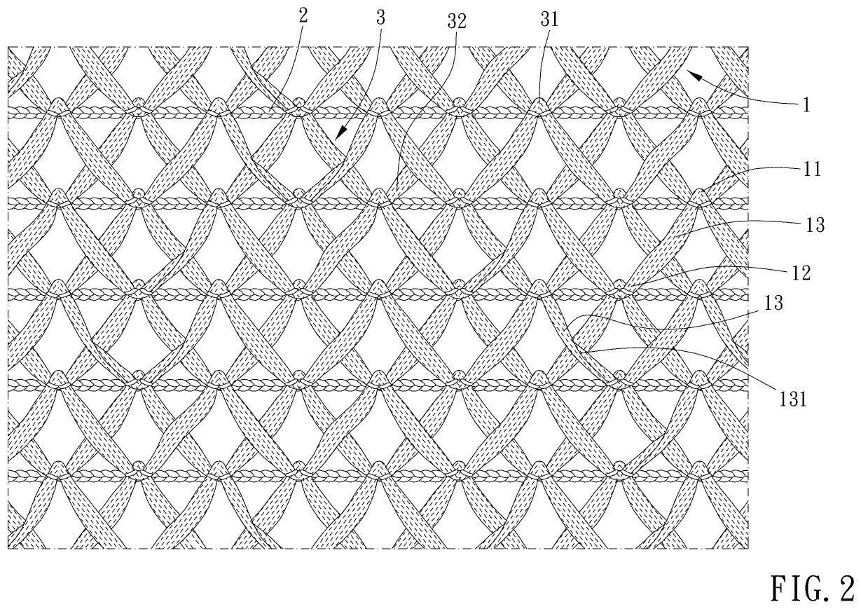

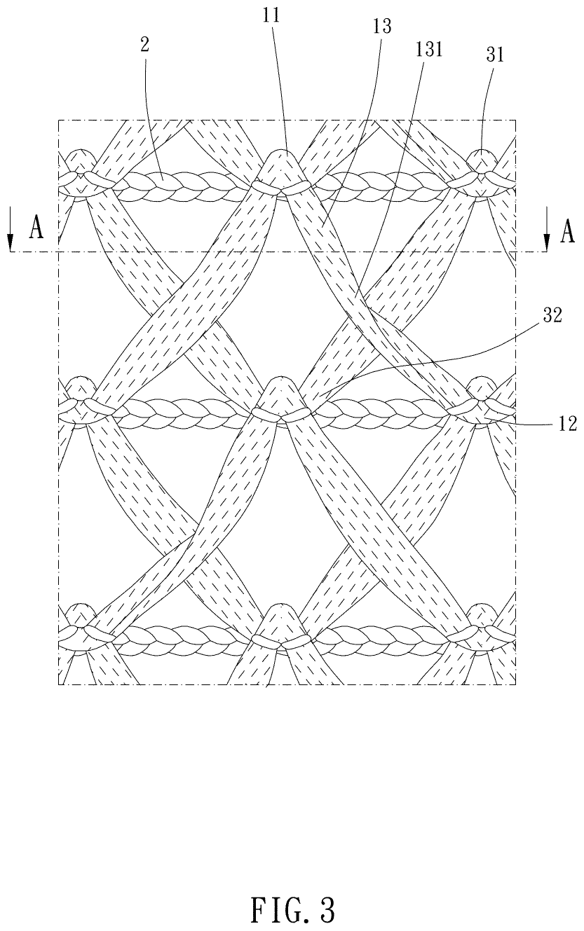

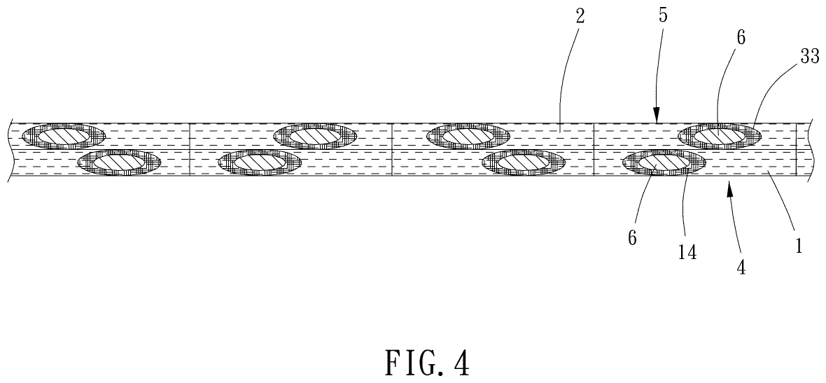

Please refer to FIGS. 1 to 4 for a preferable embodiment of the present invention. An absorbent ecological fabric of the present invention includes at least one first fiber element 1, each of the at least one first fiber element 1 is absorbent and elongate, and each of the at least one first fiber element 1 is woven by a plurality of filaments. In this embodiment, the absorbent ecological fabric includes a plurality of fiber elements. Since the at least one first fiber element 1 is woven by a plurality of the filaments, it has good capillarity for absorbing water. Preferably, the filament is made of cotton. Therefore, the absorbent ecological fabric is good for planting plants (especially for climbing plants). Each of the at least one first fiber element 1 is woven by a plurality of the filaments so that any part of the entire area of the absorbent ecological fabric the absorbent can be served for attachment and climbing of plants. In an exemplary embodiment shown in FIG. 1, an end of the absorbent ecological fabric may be inserted into soil, and the absorbent ecological fabric can absorb water and nutrients and transport them to the plants.

Specifically, the absorbent ecological fabric further includes a plurality of binding elements 2, and the plurality of binding elements 2 are configured in intervals and woven with the at least one first fiber element 1. Each of the plurality of binding elements 2 is woven by a plurality of filaments.

In this embodiment, the at least one first fiber element 1 extends windingly in a first direction and includes a plurality of first winding portions 11 and a plurality of second winding portions 12 which are alternatively arranged with the plurality of first winding portions 11. Each said first winding portion 11 and one said second winding portion 12 which are adjacent to each other are provided with a connection section 13 therebetween, and the plurality of binding elements 2 are arranged in intervals in a second direction lateral to the first direction. The at least one first fiber element 1 forms a plurality of meshes which are advantageous for plants to climb and have good breathability for avoiding decay of the at least one first fiber element 1. Preferably, at least one said connection section 13 is twisted to form a twisted section 131 along which the plants can entwine around the twisted section 131 so that the plants can be firmly attached to the absorbent ecological fabric and well grown.

Specifically, the absorbent ecological fabric further includes a first layer 4 and a second layer 5, and the first layer 4 and the second layer 5 are stacked in a third direction which is lateral to the first direction and the second direction. The first layer 4 includes the at least one first fiber element 1, and the second layer 5 includes at least one second fiber element 3. The at least one second fiber element 3 is absorbent and elongate, and the at least one second fiber element 3 is woven by a plurality of filaments. The plurality of binding elements 2 fixedly knot and tie the at least one first fiber element 1 and the at least one second fiber element 3 at contacting portions of the at least one first fiber element 1 and the at least one second fiber element 3 so that either of the first layer 4 and the second layer 5 can be served for attachment and climbing of the plants and can absorb and transport more water and nutrients.

In this embodiment, the at least one first fiber element 1 and the at least one second fiber element 3 are the same in material, radial size and weaving. In other embodiments, the at least one first fiber element and the at least one second fiber element may be different in material, radial size and weaving. In this embodiment, the at least one second fiber element 3 extends windingly in the first direction and includes a plurality of third winding portions 31 and a plurality of fourth winding portions 32 which are alternatively arranged with the plurality of third winding portions 31. Each said first winding portion 11 and each said third winding portion 31 are directed toward one side of the absorbent ecological fabric in the second direction, and each said second winding portion 12 and each said fourth winding portion 32 are directed toward another side of the absorbent ecological fabric in the second direction.

Each said first winding portion 11 is located between adjacent two of the plurality of second winding portions 12, and each said third winding portions 31 is located between adjacent two of the plurality of fourth winding portions 32. The plurality of binding elements 2 fixedly knot and tie the plurality of first winding portions 11 and the plurality of fourth winding portions 32 and fixedly knot and tie the plurality of second winding portion 12 and the plurality of third winding portions 31.

Each of the at least one first fiber element 1 is a flat strip, and each of the at least one second fiber element 3 is a flat strip. Preferably, each of the at least one first fiber element 1 includes a first surface layer 14 which is woven by a plurality of filaments and is hollow, and each of the at least one second fiber element 3 includes a second surface layer 33 which is woven by a plurality of filaments and is hollow, so that it can provide good water absorption and nutrients transportation.

Each said first surface layer 14 and each said second surface layer 33 are respectively disposed around an absorbent core 6, which enhances structural strength of the at least one first fiber element 1 and the at least one second fiber element 3, and the core 6 is preferably good in water retention.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An absorbent ecological fabric, including:
at least one first fiber element, each of the at least one first fiber element being absorbent and elongate, each of the at least one first fiber element being woven by a plurality of filaments.

2. The absorbent ecological fabric of claim 1, further including a plurality of binding elements, the plurality of binding elements being configured in intervals and woven with the at least one first fiber element.

3. The absorbent ecological fabric of claim 2, wherein the at least one first fiber element extends windingly in a first direction and includes a plurality of first winding portions and a plurality of second winding portions which are alternatively arranged with the plurality of first winding portions, each said first winding portion and one said second winding portion which are adjacent to each other are provided with a connection section therebetween, and the plurality of binding elements are arranged in intervals in a second direction lateral to the first direction.

4. The absorbent ecological fabric of claim 3, wherein at least one said connection section is twisted to form a twisted section.

5. The absorbent ecological fabric of claim 3, further including a first layer and a second layer, the first layer and the second layer are stacked in a third direction which is lateral to the first direction and the second direction, the first layer includes the at least one first fiber element, the second layer includes at least one second fiber element, the at least one second fiber element is absorbent and elongate, each of the at least one second fiber element is woven by a plurality of filaments, and the plurality of binding elements fixedly knot and tie the at least one first fiber element and the at least one second fiber element at contacting portions of the at least one first fiber element and the at least one second fiber element.

6. The absorbent ecological fabric of claim 5, wherein the at least one second fiber element extends windingly in the first direction and includes a plurality of third winding portions and a plurality of fourth winding portions which are alternatively arranged with the plurality of third winding portions.

7. The absorbent ecological fabric of claim 5, wherein each of the at least one first fiber element is a flat strip, and each of the at least one second fiber element is a flat strip.

8. The absorbent ecological fabric of claim 7, wherein each of the at least one first fiber element includes a first surface layer which is woven by a plurality of filaments and is hollow, and each of the at least one second fiber element includes a second surface layer which is woven by a plurality of filaments and is hollow.

9. The absorbent ecological fabric of claim 6, wherein each said first winding portion is located between adjacent two of the plurality of second winding portions, each said third winding portion is located between adjacent two of the plurality of fourth winding portions, and the plurality of binding elements fixedly knot and tie the plurality of first winding portions and the plurality of fourth winding portions and fixedly knot and tie the plurality of second winding portion and the plurality of third winding portions.

10. The absorbent ecological fabric of claim 4, wherein the absorbent ecological fabric further includes a first layer and a second layer, the first layer and the second layer are stacked in a third direction which is lateral to the first direction and the second direction, the first layer includes the at least one first fiber element, the second layer includes at least one second fiber element, the at least one second fiber element is absorbent and elongate, each of the at least one second fiber element is woven by a plurality of filaments, and the plurality of binding elements fixedly knot and tie the at least one first fiber element and the at least one second fiber element at contacting portions of the at least one first fiber element and the at least one second fiber element; third winding portions; each of the at least one first fiber element is a flat strip, and each of the at least one second fiber element is a flat strip; each of the at least one first fiber element includes a first surface layer which is woven by a plurality of filaments and is hollow, and each of the at least one second fiber element includes a second surface layer which is woven by a plurality of filaments and is hollow; each said first winding portion is located between adjacent two of the plurality of second winding portions, each said third winding portion is located between adjacent two of the plurality of fourth winding portions, and the plurality of binding elements fixedly knot and tie the plurality of first winding portions and the plurality of fourth winding portions and fixedly knot and tie the plurality of second winding portion and the plurality of third winding portions; each said first surface layer and each said second surface layer are respectively disposed around an absorbent core; each said first winding portion and each said third winding portion are directed toward one side of the absorbent ecological fabric in the second direction, each said second winding portion and each said fourth winding portion are directed toward another side of the absorbent ecological fabric in the second direction; each of the plurality of binding elements is woven by a plurality of filaments.
